(19) United States
(12) Patent Application Publication
(10) Pub. No.: US 2008/0236218 A1
(43) Pub. Date: Oct. 2, 2008

(54) Steering Wheel Locking Device

(76) Inventor: Chia-Lin Chen, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/694,080

(22) Filed: Mar. 30, 2007

(51) Int. Cl. B60R 25/02

(52) U.S. Cl. 70/209

(57) ABSTRACT

A steering wheel locking device includes a lock rod, a lock base, a locking device and a fixing unit. The lock rod has a chamber, two pairs of first holes longitudinally aligned, a lock hole and a saddle. The lock base comprises a lock core to be inserted into the lock base through the lock hole. The top of the lock core is provided with a latch. The locking device has a pair of second holes in register with the pairs of first holes of the lock rod, and is engageable with the latch and moveable transversely along the lock rod between a locked position and an unlocked position. The fixing unit comprises a pair of fixing rods in register with the pairs of first holes of the lock rod and the pair of second holes of the locking device. The fixing rods are moveable longitudinally through the pairs of first holes and the pair of second holes to lock or unlock the locking device.

### BACKGROUND OF THE INVENTION

1. Field of the Invention

The present invention relates to a steering wheel locking device, and more particularly to a fixing unit which can lock the ribs of a steering wheel within a limited operation space and still provide the same anti-theft effect.

2. Description of the Prior Art

Automobiles are an important means of transportation in our daily life. People rely on them for work, shopping or many other uses. In order to reduce car theft there have been a number of anti-theft car steering wheel locks developed. As shown in FIG. 9, a conventional steering wheel lock device comprises a lock rod A having through holes A2 thereon. A lock core A1 is provided in the lock rod A. The lock rod A comprises a bridge A3 at one side and a swivel body B at one end. The swivel body B comprises engaging studs B1 corresponding in position to the through holes A2. The engaging studs B1 extend through the through holes A2 and are controlled by the swivel body B to move along the through holes A2.

To operate the steering wheel locking device, as shown in FIG. 10, swing the engaging studs B1 away from the bridge A3 of the lock rod A to place the ribs of the steering wheel C in between the engaging studs B1 and the bridge A3. Then swing the engaging studs B1 back to their position engaging with the bridge A3, as shown in FIG. 11.

However, the locking process is not easy. The user may have to try a few times before they can lock the steering wheel because the space between the engaging studs B1 and the bridge A3 is very limited.

### SUMMARY OF THE INVENTION

It is the primary advantage of the present invention to provide a steering wheel locking device, which is easy to operate by providing a fixing unit which operates in a linear manner.

It is another advantage of the present invention to provide a steering wheel locking device, which requires less space to perform the locking and unlocking of the fixing unit without bumping into other objects in a vehicle.

It is a further advantage of the present invention to provide a steering wheel locking device, which secures the rib of a steering wheel within fixing rods of the fixing unit to provide a better anti-theft effect.

It is still a further advantage of the present invention to provide a steering wheel locking device, which has a protection design to prevent theft through removal of a lock core and defeating the lock.

According to the present invention, there is provided a steering wheel locking device comprising a lock rod comprising a chamber, two pairs of first holes longitudinally aligned, a lock hole, and a saddle; a lock base comprising a lock core, said lock core being insertable through said lock hole into said lock base, said lock core comprising a latch at one end thereof; a locking device having a pair of second holes in register with said pairs of first holes of said lock rod, said locking device being engageable with said latch of said lock core and moveable transversely along said lock rod; and a fixing unit comprising a pair of fixing rods in register with said pairs of first holes of said lock rod and said pair of second holes of said locking device, said fixing rods being moveable longitudinally through said pairs of first holes and said pair of second holes to lock or unlock said locking device; whereby, in use said saddle is positioned over a steering wheel rim with said fixing rods positioned on either side of a steering wheel rib.

One end of said chamber of said lock rod may be provided with a cover.

The said lock core may be secured by a pin to said lock base.

The said lock base may be formed with a locking hole and one end of said locking device may be provided with an engaging rod and a spring, the bottom of said engaging rod being formed with a trough, said engaging rod and said spring being inserted into said locking hole of said lock base and secured by said latch of said lock core to position said locking device.

The said locking device is provided with studs next to said second holes, and said fixing rods of said fixing unit may be formed with locating troughs for engagement of said studs.

The said locking device may further comprises a resilient element, and one of said fixing rods of said fixing unit may be formed with a recess for said resilient element to seat therein.

The said latch may be formed with a hole to accommodate a spring and a restraining pin, and said locking device may be formed with a restraining trough to accommodate said restraining pin of said latch.

### BRIEF DESCRIPTION OF THE DRAWINGS

FIG. 1 is an exploded view of a preferred embodiment of the present invention;

FIG. 2 is a perspective view of the preferred embodiment of the present invention;

FIG. 3 is a side cross-sectional view of the preferred embodiment of the present invention in an open status;

FIG. 4 is a top view of the preferred embodiment of the present invention showing a lock core and a portion of an engaging rod;

FIG. 5 is a side cross-sectional view of the preferred embodiment of the present invention in a locked state;

FIG. 6 is a top view of the preferred embodiment of the present invention showing that the lock core is turned 90 degrees and a latch is no longer engaged with the engaging rod;

FIG. 7 is a top cross-sectional view of the preferred embodiment of the present invention in an operating state;

FIG. 8 is a perspective view of a steering wheel locked by the present invention;

FIG. 9 is a perspective view of the prior art;

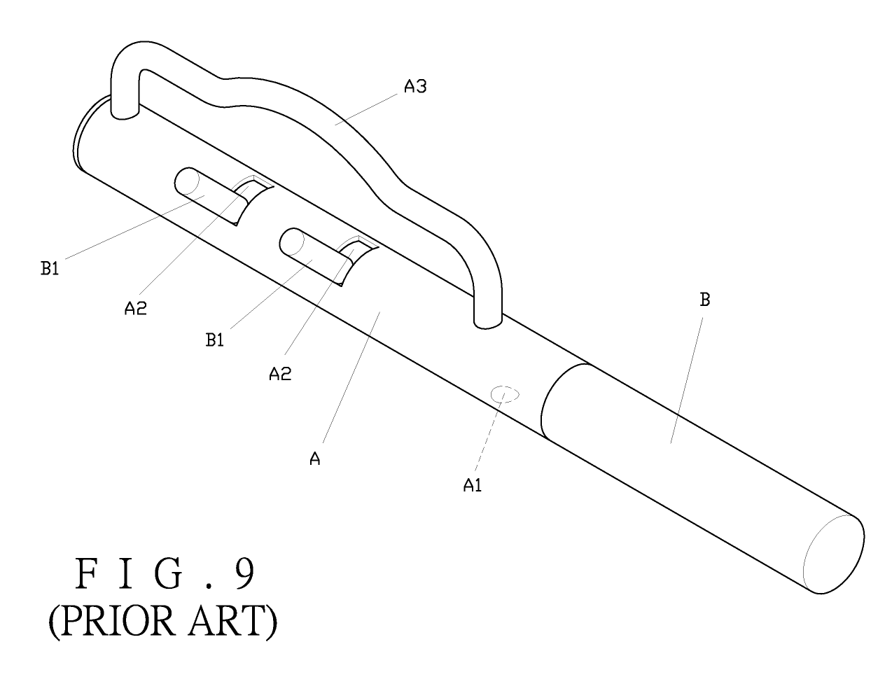

FIG. 10 is a perspective view of the prior art in an operating mode; and

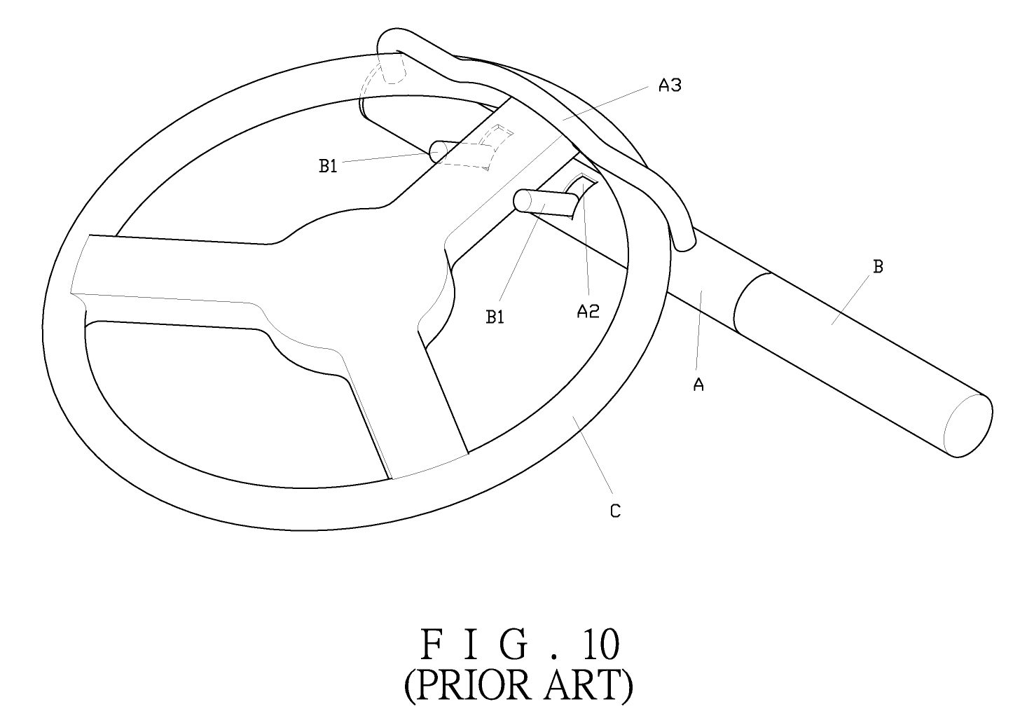

FIG. 11 is a perspective view of a steering wheel locked by the prior art.

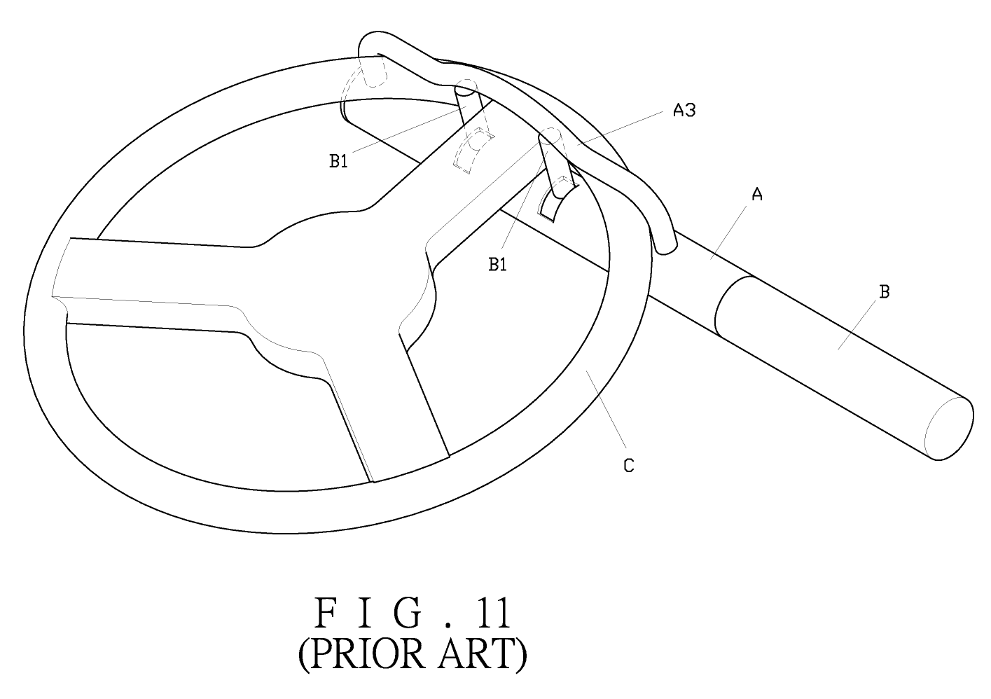

### DETAILED DESCRIPTION OF THE PREFERRED EMBODIMENT

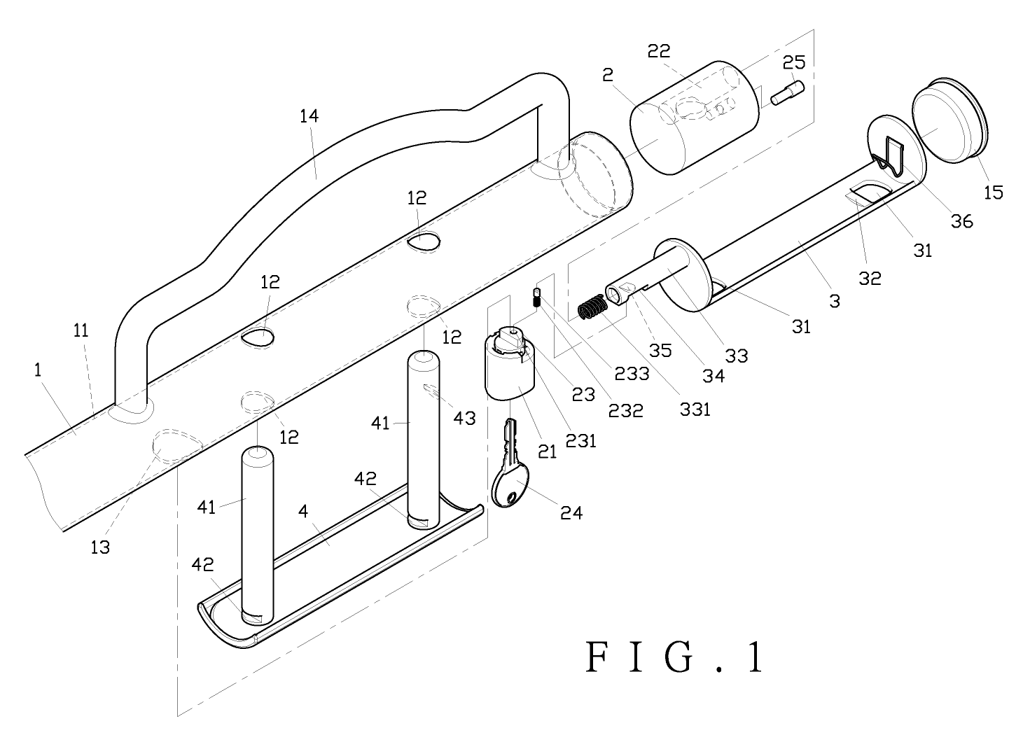

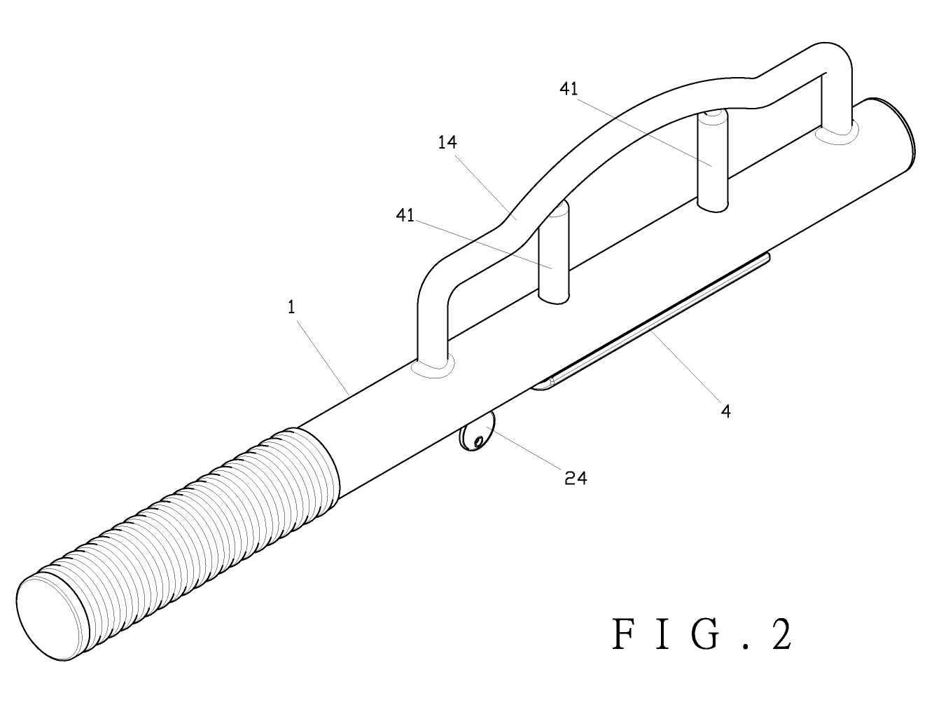

As shown in FIGS. 1 and 2, a preferred embodiment of the present invention comprises a lock rod 1, a lock base 2, a locking device 3 and a fixing unit 4.

The lock rod 1 comprises a chamber 11 therein. The lock rod 1 has two pairs of first holes 12 longitudinally aligned and a lock hole 13. The lock rod 1 further comprises a saddle 14 extending outwardly of the chamber 11, and a cover 15 over the chamber 11.

The lock base 2 comprises a lock core 21 which is inserted through the lock hole 13 into the lock base 2 and secured by a pin 25. The lock base 2 is formed with a locking hole 22. A latch 23 is formed at the top of the lock core 21. A key 24 is used to activate the lock core 21. The latch 23 has a hole 231 to locate a spring 232 and a restraining pin 233 therein.

The locking device 3 has a pair of second holes 31, each hole having a stud 32 at one side thereof. The second holes 31 of the locking device 3 are in register with the pairs of first holes 12 of the lock rod 1. The locking device 3 has an engaging rod 33 at one end thereof which is provided with a spring 331. The spring 331 and the engaging rod 33 are inserted into the locking hole 22 of the lock base 2 such that the locking device 3 is moveable transversely within the lock rod 1. The engaging rod 33 is formed with a trough 34 on a lower portion which is engageable with the latch 23 of the lock core 21 to secure the locking device 3 in place. The engaging rod 33 further has a restraining trough 35 within the trough 34. The locking device 3 further comprises a resilient element 36.

The fixing unit 4 comprises a pair of fixing rods 41 in register with the pairs of first holes 12 of the lock rod 1 and the second holes 31 of the locking device 3 such that the fixing rods 41 can be controlled by the locking device 3 to slide along the first holes 12 and the second holes 31. The fixing rods 41 have locating troughs 42 to accept the studs 32 in order to secure the fixing rods 41 in their locked position. When the studs 32 engage with the locating troughs 42, the fixing unit 4 will be in a locked state. One of the fixing rods 41 is formed with a recess 43 to accommodate the resilient element 36 of the locking device 3 therein.

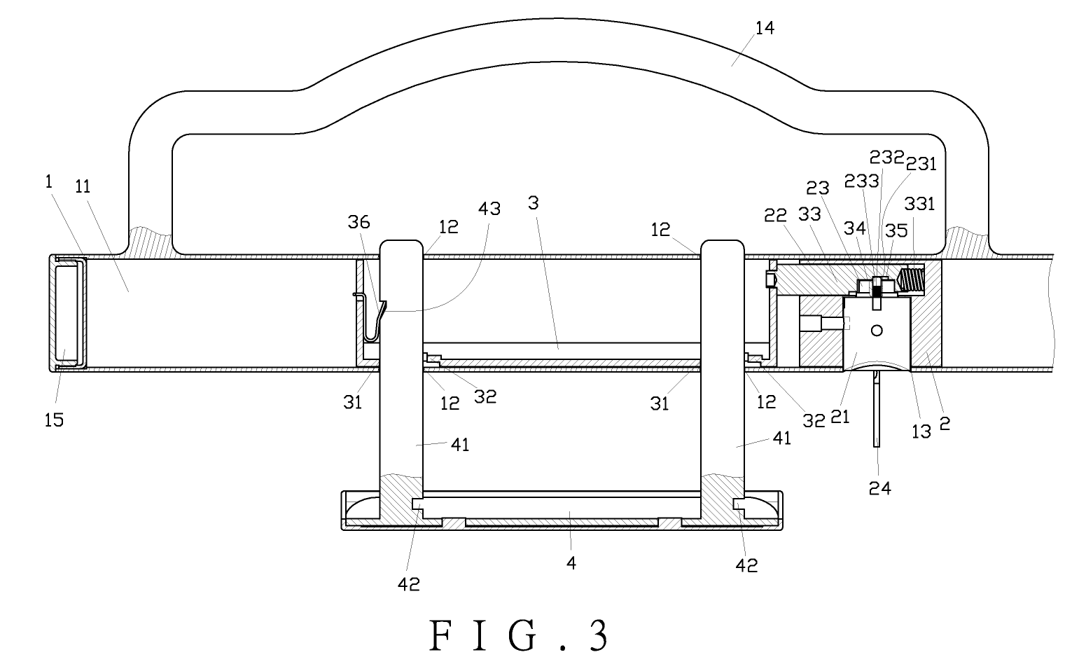

To assemble the present invention, as shown in FIG. 3, the lock base 2 is placed into the chamber 11 of the lock rod 1, corresponding in position to the lock hole 13 of the lock rod 1. The locking device 3 is then inserted into the chamber 11, and the engaging rod 33 and the spring 331 are inserted into the locking hole 22. The lock core 21 is inserted into the lock base 2 through the lock hole 13. The latch 23 of the lock core 21 is engaged with the trough 34 of the locking device 3 to secure the locking device 3. When the fixing rods 41 of the fixing unit 4 are inserted through the first holes 12 of the lock rod 1 and the second holes 31 of the locking device 3, the resilient element 36 of the locking device 3 will be engaged with the recess 43 of the fixing rod 41 to secure the locking device 3, preventing the locking device 3 from disengagement. When all parts are assembled, the cover 15 is fitted to cover the chamber 11.

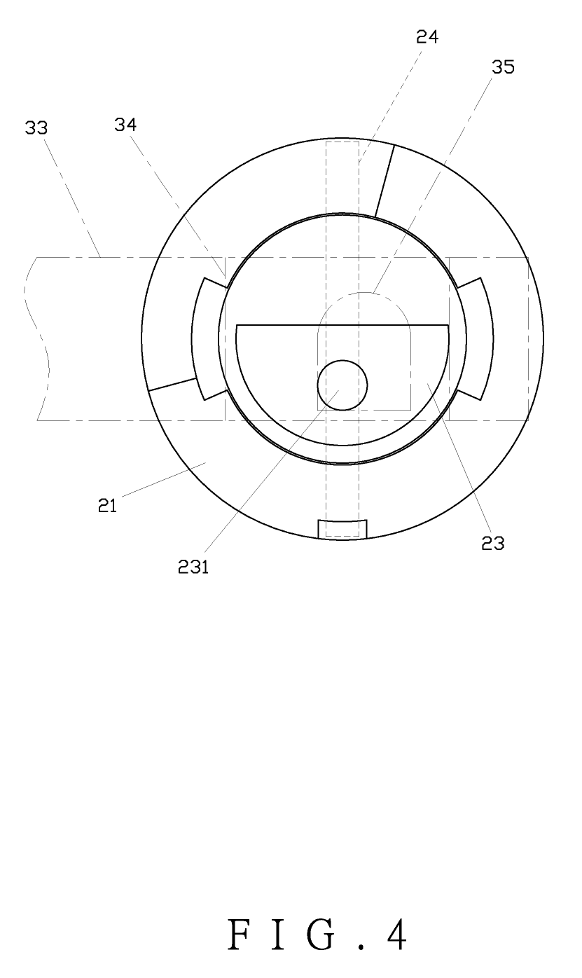

As shown in FIGS. 3 and 4, the key 24 is in a vertical unlocked position, and the latch 23 of the lock core 21 is engaged with the trough 34 of the engaging rod 33. In this position, the latch 23 pushes the engaging rod 33 and compresses the spring 331 to move the locking device 3 such that the studs 32 are disengaged from the locating troughs 42 of the fixing rods 41 and the fixing unit 4 can be pulled downward into an unlocked state without the fixing unit 4 being able to be removed from the lock rod 1.

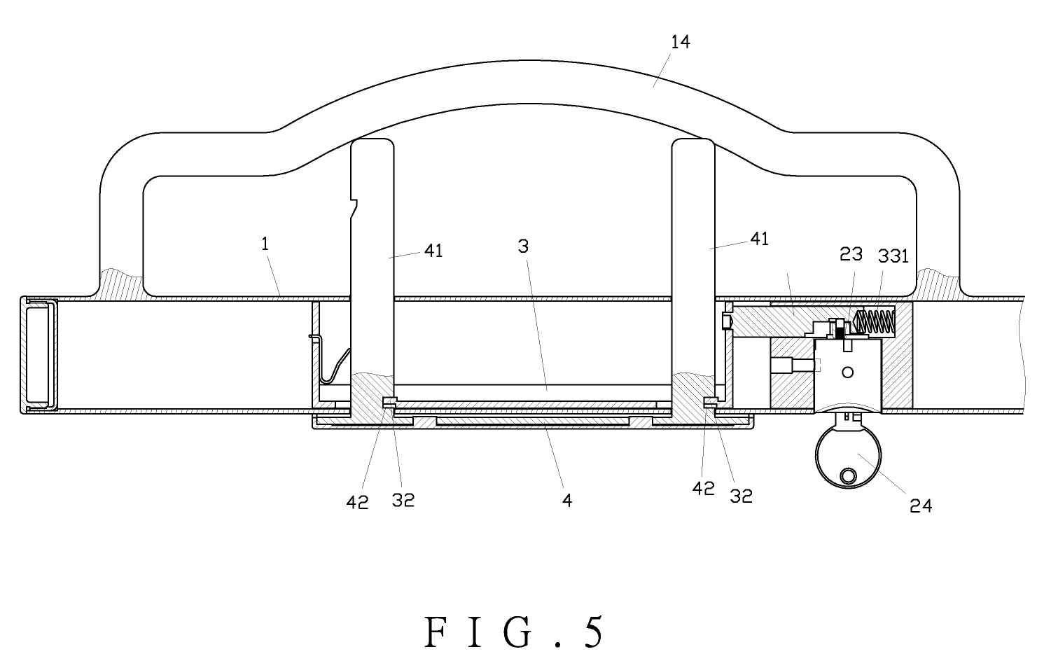

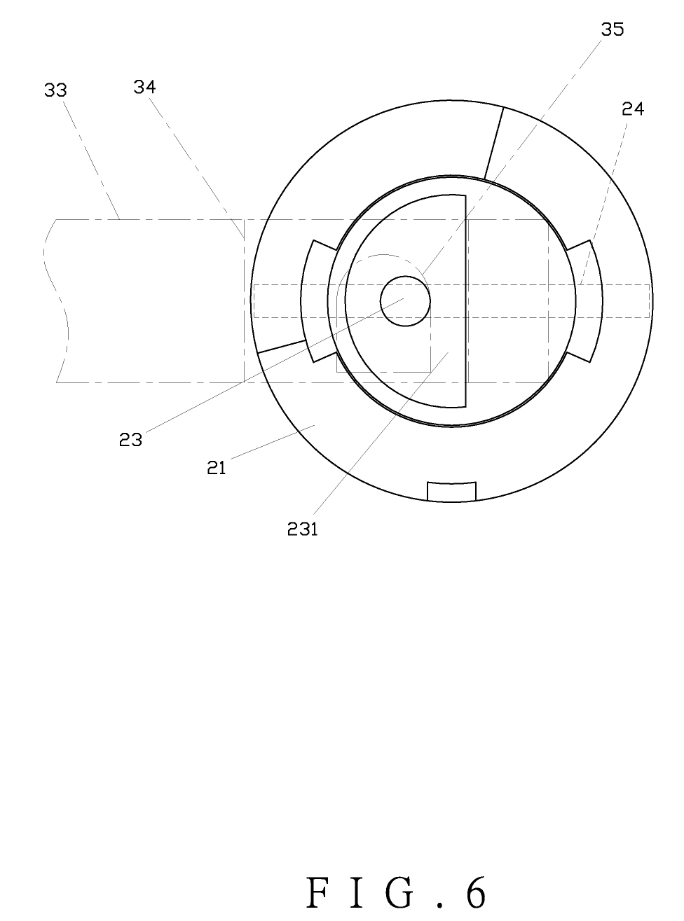

To lock the present invention, as shown in FIGS. 5 and 6, the fixing unit 4 is pushed upwards until the fixing rods 41 abut the saddle 14 of the lock rod 1. The key 24 is inserted into the lock core 21 and turned 90 degrees to move the latch 23 away from the engaging rod 33. The spring 331 pushes the locking device 3 towards the open end of the lock rod 1 causing the studs 32 of the locking device 3 to engage with the locating troughs 42 of the fixing rods 41 to complete the locking process.

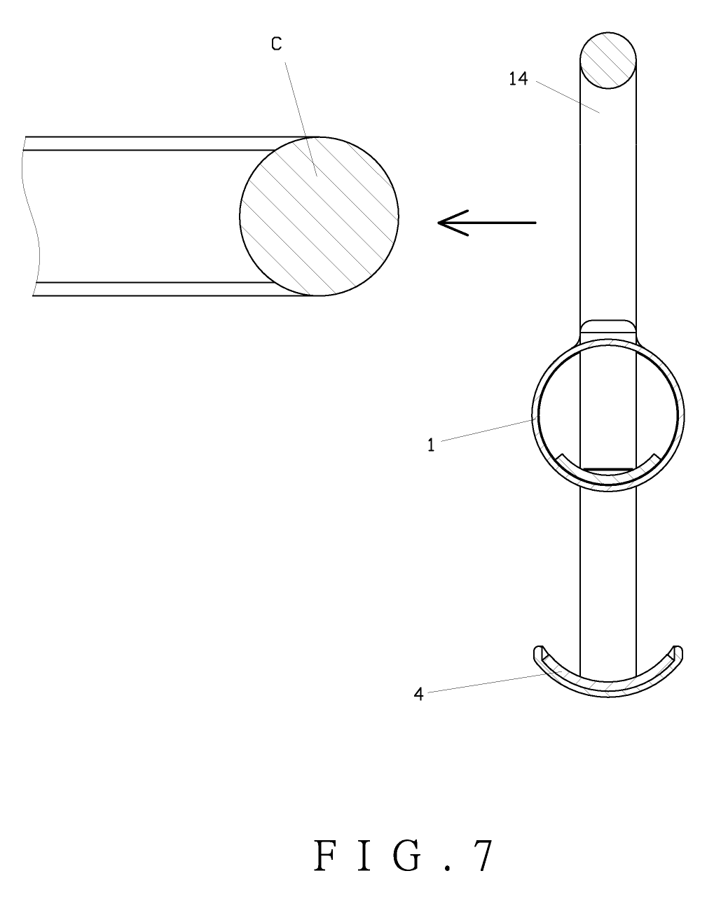

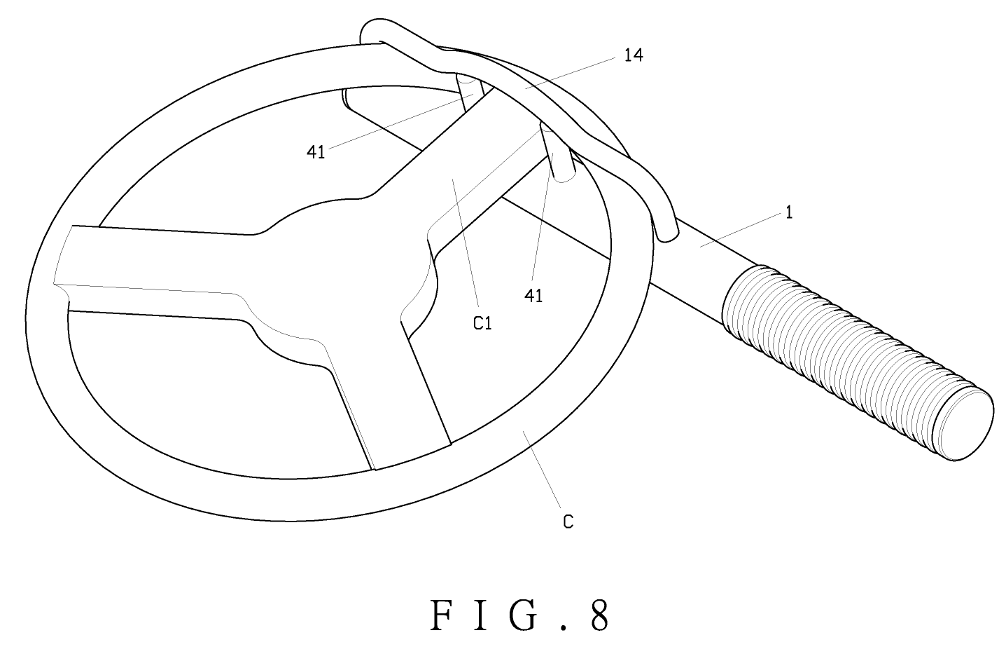

As shown in FIG. 7, the fixing unit 4 is in an unlocked state. The saddle 14 is inserted onto a steering wheel C. As shown in FIG. 8, the fixing rods 41 engage with a reinforcing rib C1 of the steering wheel C. The steering wheel C is confined by the saddle 14 from being turned, thus the steering wheel C is in a total controlled state by the lock rod 1.

The anti-theft steering wheel lock of the present invention, as shown in FIGS. 3, 4, 5 and 6, comprises a protection device which is defined by the latch 23 having the spring 232 and the restraining pin 233. The locking device 3 has the restraining trough 35. The spring 232 and the restraining pin 233 are linked by the latch 23 to rotate within the restraining trough 35, which means when the locking device 3 is hit by illegal force, the studs 32 of the locking device 3 will not be forced to detach from the locating troughs 42 of the fixing rods 41, thus the vehicle is effectively protected from theft.

A steering wheel locking device includes a lock rod, a lock base, a locking device and a fixing unit. The lock rod has a chamber, two pairs of first holes longitudinally aligned, a lock hole and a saddle. The lock base comprises a lock core to be inserted into the lock base through the lock hole. The top of the lock core is provided with a latch. The locking device has a pair of second holes in register with the pairs of first holes of the lock rod, and is engageable with the latch and moveable transversely along the lock rod between a locked position and an unlocked position. The fixing unit comprises a pair of fixing rods in register with the pairs of first holes of the lock rod and the pair of second holes of the locking device. The fixing rods are moveable longitudinally through the pairs of first holes and the pair of second holes to lock or unlock the locking device.

What is claimed is:

1. A steering wheel locking device, comprising:
a lock rod comprising a chamber, two pairs of first holes longitudinally aligned, a lock hole, and a saddle;
a lock base comprising a lock core, said lock core being insertable through said lock hole into said lock base, said lock core comprising a latch at one end thereof;
a locking device having a pair of second holes in register with said pairs of first holes of said lock rod, said locking device being engageable with said latch of said lock core and moveable transversely along said lock rod between a locked position and an unlocked position; and
a fixing unit comprising a pair of fixing rods in register with said pairs of first holes of said lock rod and said pair of second holes of said locking device, said fixing rods being moveable longitudinally through said pairs of first holes and said pair of second holes to lock or unlock said locking device;
whereby, in use said saddle is positioned over a steering wheel rim with said fixing rods positioned on either side of a steering wheel rib.

2. The steering wheel locking device, as recited in claim 1, wherein one end of said chamber of said lock rod is provided with a cover.

3. The steering wheel locking device, as recited in claim 1, wherein said lock core is secured by a pin to said lock base.

4. The steering wheel locking device, as recited in claim 1, wherein said lock base is formed with a locking hole and one end of said locking device is provided with an engaging rod and a spring, the bottom of said engaging rod being formed with a trough, said engaging rod and said spring being inserted into said locking hole of said lock base and secured by said latch of said lock core to position said locking device.

5. The steering wheel locking device, as recited in claim 1, wherein said locking device is provided with studs next to said second holes, and said fixing rods of said fixing unit are formed with locating troughs for engagement of said studs.

6. The steering wheel locking device, as recited in claim 1, wherein said locking device further comprises a resilient element, and one of said fixing rods of said fixing unit is formed with a recess for said resilient element to seat therein.

7. The steering wheel locking device, as recited in claim 1, wherein said latch is formed with a hole to accommodate a spring and a restraining pin, and said locking device is formed with a restraining trough to accommodate said restraining pin of said latch.
